(19) United States
(12) Patent Application Publication
(10) Pub. No.: US 2024/0312483 A1
(43) Pub. Date: Sep. 19, 2024

(54) Self-Aligned Side Gap Insulator For A Perpendicular Magnetic Recording Writer

(71) Applicant: Headway Technologies, Inc., Milpitas, CA (US)

(72) Inventors: Yu-Hsia Chen, Los Altos, CA (US); Weihao Xu, San Jose, CA (US); Jiun-Ting Lee, Sunnyvale, CA (US); Weisheng Hu, Fremont, CA (US); Yuhui Tang, Milpitas, CA (US); Yue Liu, Fremont, CA (US)

(21) Appl. No.: 18/122,362

(22) Filed: Mar. 16, 2023

(51) Int. Cl. G11B 5/11; G11B 5/127

(52) U.S. Cl. CPC G11B 5/112; G11B 5/1278

(57) ABSTRACT

The present embodiments relate to a perpendicular magnetic recording (PMR) write head with a self-aligned side gap insulator. A self-aligned SG oxide insulator can reduce or eliminate the current from MP to SS. The SG insulator can force the writer current to go through a writer gap and leading gap, which can improve ATI and TPI performance.

### TECHNICAL FIELD

Embodiments of the invention relate to the field of perpendicular magnetic recording (PMR) write heads for a hard disk drive (HDD). More particularly, embodiments of the invention relate to the field of a PMR write head comprising a self-aligned side gap insulator.

### BACKGROUND

Volumes of digital data can be stored on a disk drive, such as a Hard disk drive (HDD). The disk drive can comprise a head that can interact with a magnetic recording medium (e.g., a disk) to read and write magnetic data onto the disk. For instance, the disk drive can include a write head that is positioned near the disk and can modify a magnetization of the disk passing immediately under the write head.

Disk drives can utilize various technologies to write to a disk. For example, perpendicular magnetic recording (PMR) can relate to magnetic bits on a disk are directed perpendicular (e.g., either up or down) relative to the disk surface. PMR recording can increase storage density to the disk by aligning poles of magnetic elements on the disk perpendicularly to the surface of the disk.

### SUMMARY

A perpendicular magnetic recording (PMR) write head with a self-aligned side gap insulator is described. In a first example embodiment, a perpendicular magnetic recording (PMR) write head is provided. The PMR write head can include a leading shield and a side shield connected to the leading shield. Portions of the side shield can form a cavity.

The PMR write head can also include a side gap insulator disposed within the cavity. In some instances, the side gap insulator is configured to cause a current to flow between the main pole and the leading shield. In some instances, the side gap insulator comprises an oxide material. In some instances, the side gap insulator is disposed along each sidewall of the metallic side gap formed in the cavity.

The PMR write head can also include a metallic side gap with at least a portion disposed in the cavity and interior of the side gap insulator layer. The PMR write head can also include a main pole with at least a portion disposed in the cavity and interior of the metallic side gap.

In some instances, the PMR write head can also include an additional insulator layer disposed between the side gap insulator and the side shield.

In some instances, the additional insulator layer comprises aluminum oxide (AlOx). In some instances, the additional insulator layer comprises a thickness of between 10-500 angstroms (Å).

In another example embodiment, a method for manufacturing a perpendicular magnetic recording (PMR) write head is provided. The method can include forming a leading shield. The method can also include disposing a side shield on a first surface of the leading shield. The side shield can include at least one sidewall portion forming a cavity therein.

The method can also include performing an ion milling process at the cavity to form a side gap insulator on the at least one sidewall portion. The method can also include disposing at least a portion of a metallic side gap in the cavity adjacent to the side gap insulator. The method can also include disposing at least a portion of a main pole in the cavity adjacent to the metallic side gap.

In some instances, the side gap insulator comprises an oxide material. In some instances, the ion milling process is performed at an angle of between 0-70 degrees, and an amount milled during the ion milling process is between 50-1000 angstroms (Å).

In some instances, the method can also include providing a current to any part of the PMR write head, wherein the current flows between the main pole and the leading shield. In some instances, the method can also include, after disposing the side shield and prior to performing the ion milling process, disposing an additional insulator layer on the at least one sidewall of the side shield.

In some instances, the additional insulator layer comprises aluminum oxide (AlOx) or other oxides, and wherein the additional insulator layer comprises a thickness of between 10-500 angstroms (Å).

In another example embodiment, a device is provided. The device can include a leading shield and a side shield connected to the leading shield. Sidewall portions of the side shield can form a cavity. The device can also include a side gap insulator disposed within the cavity along the sidewall portions of the side shield.

In some instances, the device can include a metallic side gap with at least a portion disposed in the cavity and interior of the side gap insulator layer and a main pole with at least a portion disposed in the cavity and interior of the metallic side gap.

In some instances, the side gap insulator is configured to cause a current to flow between the main pole and the leading shield. In some instances, the side gap insulator comprises an oxide material.

In some instances, the device can include an additional insulator layer disposed between the side gap insulator and the side shield. In some instances, the additional insulator layer comprises aluminum oxide (AlOx) or other oxides. In some instances, the additional insulator layer comprises a thickness of between 10-500 angstroms (Å).

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a perspective view of a head arm assembly, according to some embodiments of the present disclosure.

FIG. 2 is side view of a head stack assembly, according to some embodiments of the present disclosure.

FIG. 3 is a plan view of a magnetic recording apparatus, according to some embodiments of the present disclosure.

FIG. 4 is a down-track cross-sectional view of a combined read-write head with complete trailing and leading magnetic flux return loops, according to some embodiments of the present disclosure.

FIG. 5 is a down-track cross-sectional view of a PMR writer having a uDY design for the trailing loop and a rDWS BGC layout for the leading loop, according to some embodiments of the present disclosure.

FIG. 6 is a side view of part of a PMR writer after side shield plating.

FIG. 7 is a side view of a PMR writer with a self-aligned SG insulator.

### DETAILED DESCRIPTION

Disk drives can utilize various technologies to write to a disk. For example, perpendicular magnetic recording (PMR) can relate to magnetic bits on a disk are directed perpendicular (e.g., either up or down) relative to the disk surface. PMR recording can increase storage density to the disk by aligning poles of magnetic elements on the disk perpendicularly to the surface of the disk.

Further, a disk drive head can include a main pole (MP) with a tip portion configured to be disposed near the surface of the disk. The distance between the main pole tip portion and the disk can be controlled by a dynamic fly height (DFH) writer heater. Particularly, DFH writer heater can heat a portion of the head, causing the MP to expand or contract, thereby modifying the distance between the main pole tip portion and the disk. Electrical energy can be provided to any of the DFH writer heater and the MP tip portion via electrical pads, forming a circuit in the head.

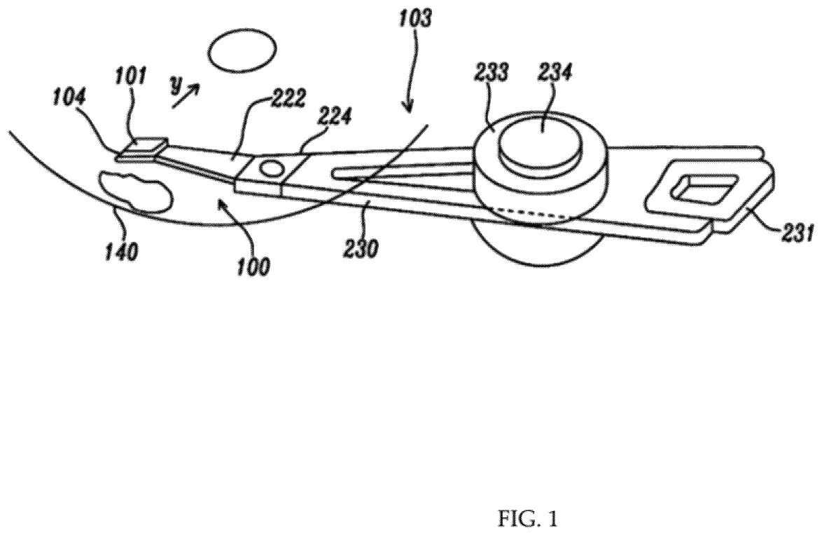

FIG. 1 is a perspective view of a head arm assembly 100, according to some embodiments of the present disclosure. Referring to FIG. 1, a head arm assembly (or Head Gimbal Assembly (HGA)) 100 includes a magnetic recording head 101 comprised of a slider and a PMR writer structure formed thereon, and a suspension 103 that elastically supports the magnetic recording head. The suspension has a plate spring-like load beam 222 formed with stainless steel, a flexure 104 provided at one end portion of the load beam, and a base plate 224 provided at the other end portion of the load beam. The slider portion of the magnetic recording head is joined to the flexure, which gives an appropriate degree of freedom to the magnetic recording head. A gimbal part (not shown) for maintaining a posture of the magnetic recording head at a steady level is provided in a portion of the flexure to which the slider is mounted.

HGA 100 is mounted on an arm 230 formed in the head arm assembly 103. The arm moves the magnetic recording head 101 in the cross-track direction y of the magnetic recording medium 140. One end of the arm is mounted on base plate 224. A coil 231 that is a portion of a voice coil motor is mounted on the other end of the arm. A bearing part 233 is provided in the intermediate portion of arm 230. The arm is rotatably supported using a shaft 234 mounted to the bearing part 233. The arm 230 and the voice coil motor that drives the arm configure an actuator.

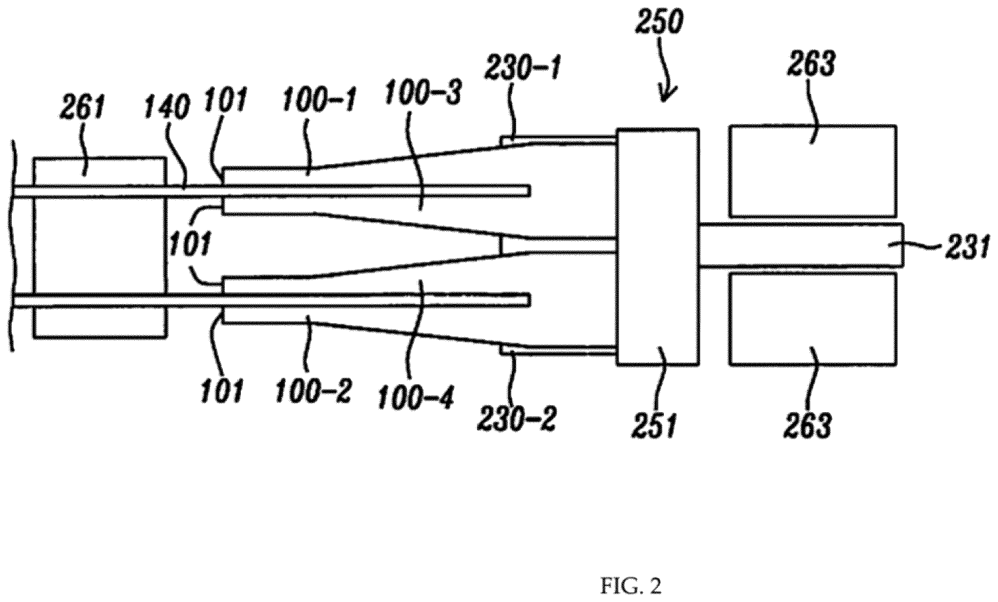

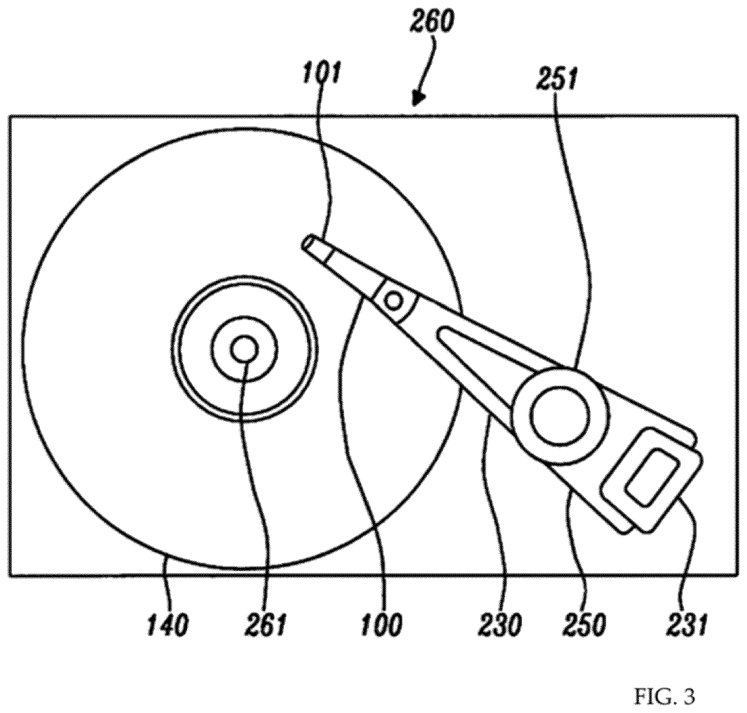

Next, a side view of a head stack assembly (FIG. 2) and a plan view of a magnetic recording apparatus (FIG. 3) wherein the magnetic recording head 101 is incorporated are depicted. The head stack assembly 250 is a member to which a plurality of HGAs (HGA 100-1 and second HGA 100-2 are at outer positions while HGA 100-3 and HGA 100-4 are at inner positions) is mounted to arms 230-1, 230-2, respectively, on carriage 251. A HGA is mounted on each arm at intervals so as to be aligned in the perpendicular direction (orthogonal to magnetic medium 140). The coil portion (231 in FIG. 1) of the voice coil motor is mounted at the opposite side of each arm in carriage 251. The voice coil motor has a permanent magnet 263 arranged at an opposite position across the coil 231.

With reference to FIG. 3, the head stack assembly 250 is incorporated in a magnetic recording apparatus 260. The magnetic recording apparatus has a plurality of magnetic media 140 mounted to spindle motor 261. For every magnetic recording medium, there are two magnetic recording heads arranged opposite one another across the magnetic recording medium. The head stack assembly and actuator except for the magnetic recording heads 101 correspond to a positioning device, and support the magnetic recording heads, and position the magnetic recording heads relative to the magnetic recording medium. The magnetic recording heads are moved in a cross-track of the magnetic recording medium by the actuator. The magnetic recording head records information into the magnetic recording media with a PMR writer element (not shown) and reproduces the information recorded in the magnetic recording media by a magneto-resistive (MR) sensor element (not shown).

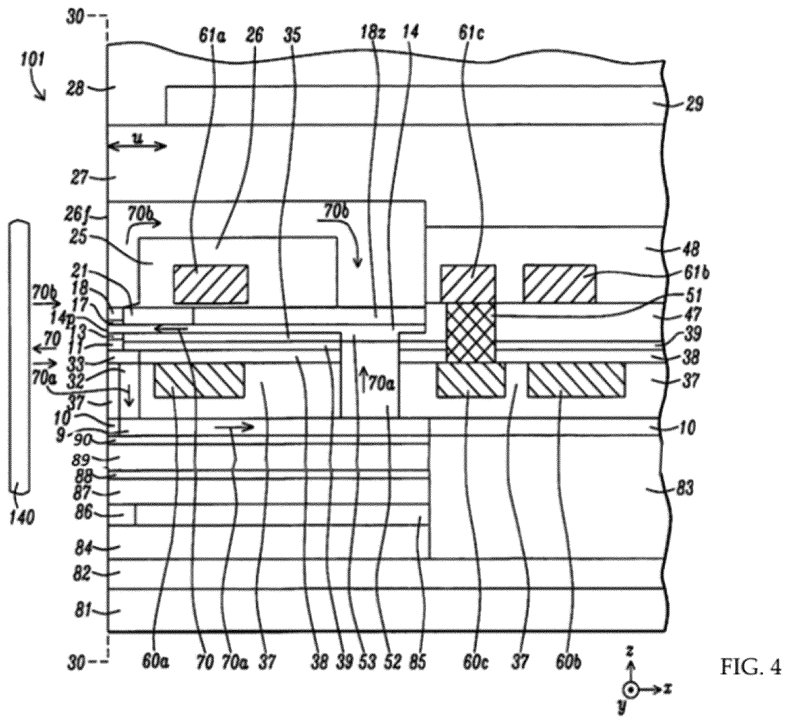

Referring to FIG. 4, magnetic recording head 101 comprises a combined read-write head. The down-track cross-sectional view is taken along a center plane formed orthogonal to the ABS 30-30, and that bisects MP 14. The read head is formed on a substrate 81 that may be comprised of AITIC (alumina+TiC) with an overlying insulation layer 82 that is made of a dielectric material such as alumina. The substrate is typically part of a slider formed in an array of sliders on a wafer. After the combined read head/write head is fabricated, the wafer is sliced to form rows of sliders. Each row is typically lapped to afford an ABS before dicing to fabricate individual sliders that are used in a magnetic recording device. A bottom shield 84 is formed on insulation layer 82.

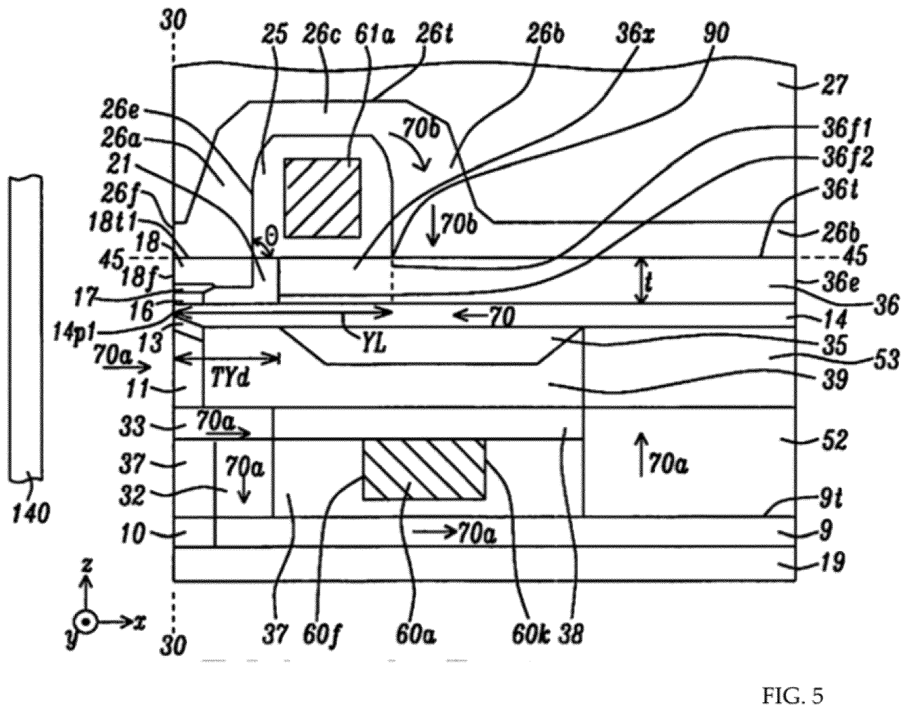

A magneto resistive (MR) element also known as MR sensor 86 is formed on bottom shield 84 at the ABS 30-30 and typically includes a plurality of layers (not shown) including a tunnel barrier formed between a pinned layer and a free layer where the free layer has a magnetization (not shown) that rotates in the presence of an applied magnetic field to a position that is parallel or antiparallel to the pinned layer magnetization. Insulation layer 85 adjoins the backside of the MR sensor, and insulation layer 83 contacts the backsides of the bottom shield and top shield 87. The top shield is formed on the MR sensor. An insulation layer 88 and a second top shield (S2B) layer 89 and an insulation layer 90 are sequentially formed on the top magnetic shield. Note that layer 9 may be a non-magnetic layer such as an AlOx layer or a magnetic layer served as a flux return path (RTP) in the write head portion of the combined read/write head. Thus, the portion of the combined read/write head structure formed below layer 9 in FIG. 5 is typically considered as the read head. In other embodiments (not shown), the read head may have a dual reader design with two MR sensors, or a multiple reader design with multiple MR sensors.

Various configurations of a write head may be employed with the read head portion. In some embodiments, magnetic flux 70 in MP 14 is generated with flowing a current through bucking coil 60a-c and driving coil 61a-c where front portions 60a and 61a are below and above the MP, respectively, center portions 60c and 61c are connected by interconnect 51, and back portions 60b and 61b are connected to writer pads (not shown). Magnetic flux 70 exits the MP at pole tip 14p at the ABS 30-30 and is used to write a plurality of bits on magnetic media 140. Magnetic flux 70b returns to the MP through a trailing loop comprised of a trailing shield structure including HS layer 17, WS 18, and uppermost trailing (PP3) shield 26, and top yoke 18x. There is also a leading loop with a recessed DWS (rDWS) BGC layout for magnetic flux 70 a return to the MP where LSC 32 and RTP 9 are recessed from the ABS 30-30. The rDWS BGC design features leading shield (LS) 11, leading shield connector (LSC) 33, S2 connector (S2C) 32, return path (RTP) 9, lower back gap (LBG) 52, and back gap connection (BGC) 53. In another embodiment (not shown), only the LS is retained in the leading return loop in a so-called non-dual write shield (nDWS) scheme where the LSC, S2C, RTP, LBG, and BGC are omitted to enhance magnetic flux in the trailing loop. The magnetic core may also comprise a bottom yoke 35 below the MP.

Dielectric layers 10, 13, 21, 37-39, and 47-48 are employed as insulation layers around magnetic and electrical components. A protection layer 27 covers the PP3 shield and is made of an insulating material such as alumina. Above the protection layer and recessed a certain distance u from the ABS 30-30 is an optional cover layer 29 that is preferably comprised of a low coefficient of thermal expansion (CTE) material such as SiC. Overcoat layer 28 is formed as the uppermost layer in the write head.

Typically, a dynamic fly height (DFH) heater (not shown) is formed in one or more insulation (dielectric) layers in each of the read head and write head to control the extent of thermal expansion (protrusion) at the ABS and toward a magnetic medium during a read process and write process, respectively. Read gap (RG) and write gap (WG) protrusion may be tuned by the placement of the DFH heaters, and by the choice of metal or alloy selected for the DFH heaters since each DFH heater is comprised of a resistor material with a particular thermal and mechanical response to a given electrical input.

Referring to FIG. 5, an enlargement of a write head portion of a combined read-write head is shown according to some embodiments. A uDY rDWS BGC base writer design is shown where the trailing loop has an ultimate double yoke (uDY) scheme, and the leading loop has a rDWS BGC layout. Bucking coil front portion 60a has front side 60f that is recessed from the ABS 30-30, backside 60k facing LBG 52, and is formed in insulation layer 37 and above RTP top surface 9t. RTP 9 is formed on bottommost insulation layer 19. Leading shield (LS) 11 contacts a top surface of LS connector (LSC) 33 at the ABS. Insulation layer 38 adjoins a backside of the LSC and extends to a BGC front side. The leading loop for flux return 70a continues from the LS and LSC through S2C 32 and the RTP before passing upward through the lower back gap (LBG) 52 and BGC 53. The BGC contacts a bottom surface of MP 14 behind tapered bottom yoke (tBY) 35. Insulation layer 39 extends from the LS backside to the BGC front side and contacts a top surface of insulation layer 38. The tBY 35 is formed within insulation layer 39, and between the LS and BGC.

The trailing loop comprises HS layer 17, WS 18 with front side 18f at the ABS 30-30, PP3 TS 26 that has front side 26 f at the ABS, and TY 36 with top surface 36t adjoining the PP3 TS behind driving coil (DC) 61a so that magnetic flux 70b from magnetic medium 140 is able to return to MP 14. DC 61a is formed above insulation layer 21 and is surrounded on the sides and top and bottom surfaces with insulation layer 25. PP3 TS top surface 26 t arches (dome shape) over DC front portion 61a. Protection layer 27 covers the PP3 TS and is made of an insulating material such as alumina. Note that the TY has a thickness t, and height d between a front side 36f1 and backside 36e where the front side is directly below the inner corner 90 of the PP3 TS where the PP3 TS contacts plane 45-45. The uDY aspect of the trailing loop is related to the feature where the TY is comprised of a TY extension 36x having a front side 36f2 that is recessed a distance TYd of 0.8 to 1.3 microns from ABS 30-30, and a backside that interfaces with TY front side 36f1. Yoke length (YL) is defined as the distance between the ABS and TY front side 36f1. The TY extension has a thickness t of 0.3-0.8 microns, which is equal to that of TY 36. The PP3 TS has a middle portion 26c with a dome shaped top surface 26t formed above driving coil front portion 61a. A front portion 26a of the PP3 TS is formed on WS 18 and has an inner side 26e that forms an apex angle θ, preferably from 60 degrees to 80 degrees, with respect to plane 45-45 that comprises TY top surface 36t and is orthogonal to the ABS. A back portion 26b of the PP3 TS adjoins a top surface of TY 36. The PP3 TS apex angle is believed to enhance flux concentration at WS 18 and provides improved high data rate performance. A key feature is that TYd is less than YL. Driving coil front portion 61a is entirely above plane 45-45 and TY extension 36x, and within insulation layer 25.

Leading shield 11, LSB 33, S2C 32, LBG 52, BGC 53, and RTP 9 are generally made of NiFe, NiFeRe, CoFe, CoFeN, CoFeNi or the like with a saturation magnetization (Ms) value of 4 kiloGauss (KG) to 16 KG. WS 18, PP3 TS 26a-26c, TY 36, and TY extension 36t are typically made of NiFe, NiFeRe, CoFe, CoFeNi, or CoFeN having a Ms 10 kG to 19 kG while HS layer 17 and MP 14 have a Ms from 19 kG to 24 kG. In this scheme, the tBY 35 contacts a bottom surface of MP 14 below the TY extension. Although the PP3 TS 26a-c has a front side 26f at the ABS, the front side may be recessed from the ABS 30-30 in other embodiments (not shown).

A writer current from the main pole (MP) to the side shield (SS) may have an impact on the magnetization rotation within a SS body. This can degrade the Adjacent Track Interference (ATI) and Tracks Per Inch (TPI) performance of the PMR writer. For example, a side erasure of an adjacent track due to ATI can worsen TPI and ADC. To avoid poor ATI performance, the current from MP to SS can be minimized.

The present embodiments generally relate to a self-aligned SG insulator for a PMR writer. A self-aligned SG oxide insulator can be introduced to effectively reduce or eliminate the current from MP to SS. The SG insulator can force the writer current to go through a writer gap and leading gap, which can improve ATI and TPI performance.

In many PMR writer structures with a metal SG, there may not be any SG insulator along the SS side wall, so a current may flow between the MP and the SS. In the present embodiments, the SG can include an insulator (e.g., ALD or other oxides), which can insulate the MP from the SS at the SS sidewall such that current can flow between the MP and LS as there is no oxide at a bottom of the MP. With a self-aligned SG insulator on the sidewall, the SG insulator can clean the bottom oxide to have writer current flow through leading gap and writer gap.

In some instances, a current from main pole to side shield may have impact on the magnetization rotation within SS body, which could degrade the ATI and TPI performance of writer. To avoid poor ATI, minimizing current from MP to SS can be preferred. An SG insulator can effectively reduce or eliminate the current from MP to SS. Further, a self-aligned side gap insulator process can be proposed to minimize the current flow from main pole to side shield. The consistent insulated SG thickness can be obtained by this design such that current can only flow through between writer gap and leading gap. An ion milling process can be from 0˜70 deg combination and the milling amount can be from 50 A to 1000 A to control the side gap insulator thickness as needed.

To make this self-aligned SG insulator in the PMR writer, the leading shield can be formed by plating process, followed by the side shield plating process with the trench shape. After side shield plating shape is defined, an ion milling process, which can be 0˜70 deg combination and 50A˜100 0A milling amount, can be applied to mill away the bottom oxide layer and also form the oxide layer on the side shield sidewall as side gap insulator.

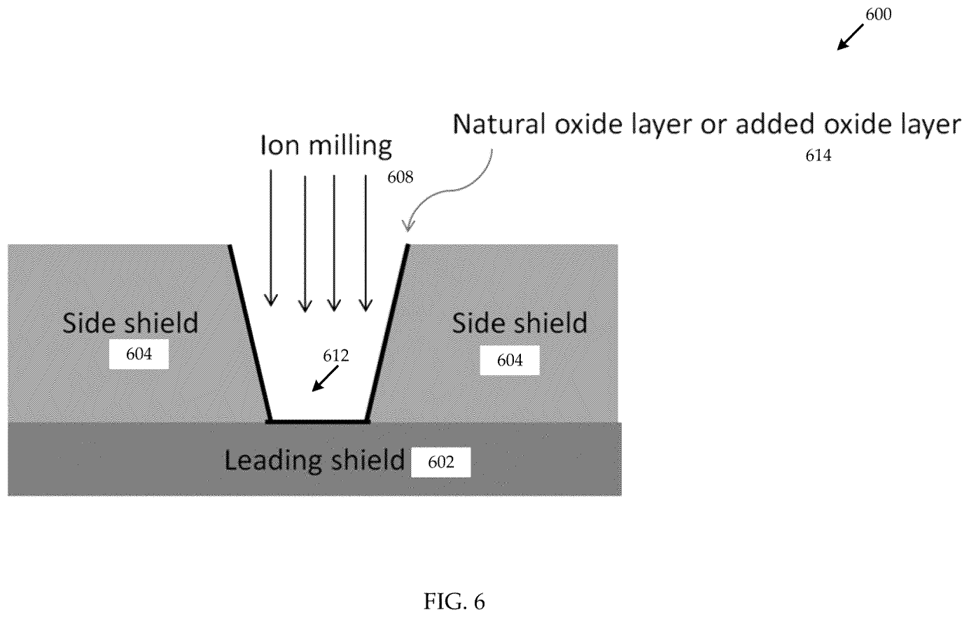

FIG. 6 is a side view 600 of part of a PMR writer after side shield plating. As shown in FIG. 6, the PMR writer can include a leading shield 602 and a side shield 604 connected to the leading shield 602. A cavity 662 can be formed in the side shield 604. Further, a natural oxide layer or an added oxide layer 614 can be disposed on any of the edges of the cavity. The layer 614 can include any of the SG insulator layer and/or the additional insulator layer as described herein. In some instances, after side shield plating, an ion milling process (e.g., 608) can be applied to form a self-aligned SG insulator design as described herein.

The oxide formed on the side wall can include a SG insulator. The SG thickness can also be adjusted by different ion milling amount. This process can provide consistent current flow between writer gap and leading gap, and no current flow through the side gap to side shield. Another alternative embodiment can include adding an additional 60˜600 A AlOx or other oxide layer after side shield plating, before the ion milling process, for further thicker oxide insulator formation. After the self-aligned SG insulator process, metal SG and MP plating can be applied.

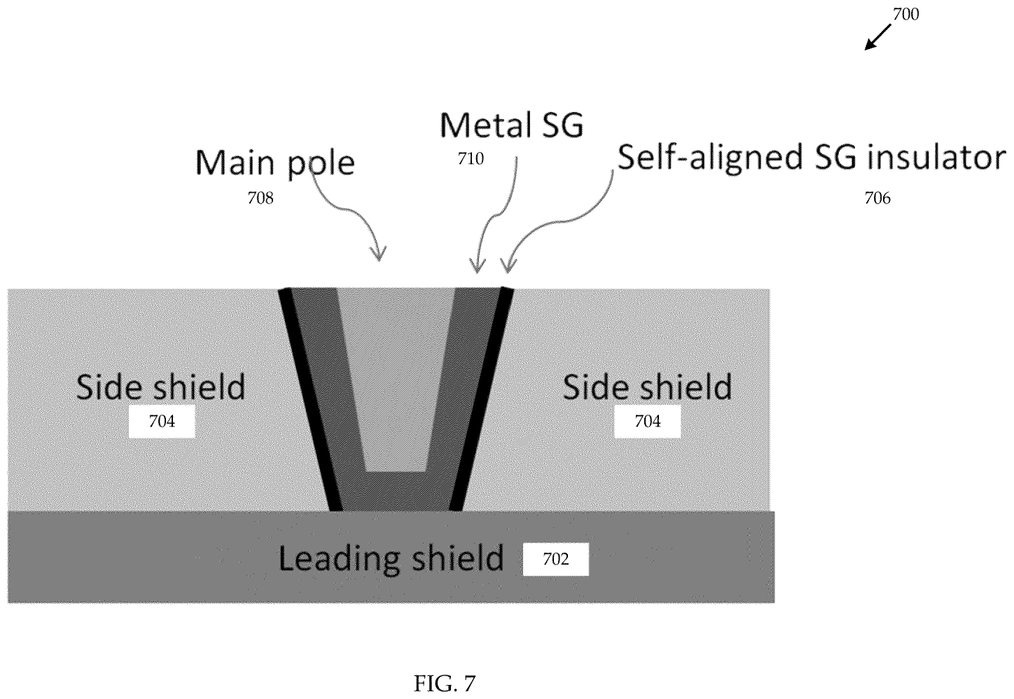

FIG. 7 is a side view 700 of a PMR writer with a self-aligned SG insulator. As shown in FIG. 7, the PMR writer 700 can include a leading shield 707, and a side shield 704 connected to the leading shield 707. Further, the cavity (e.g., 612 in FIG. 6) formed in the side shield can include a self-aligned SG insulator 706 disposed along the edges of the cavity. Further, a metal SG layer 710 can be disposed interior of the SG insulator 706. The main pole (MP) 708 can be disposed within the metal SG 710.

In a first example embodiment, a perpendicular magnetic recording (PMR) write head is provided. The PMR write head can include a leading shield (e.g., 602) and a side shield (e.g., 604) connected to the leading shield. Portions of the side shield can form a cavity (e.g., 612).

The PMR write head can also include a side gap insulator (e.g., 706) disposed within the cavity. In some instances, the side gap insulator is configured to cause a current to flow between the main pole (e.g., 708) and the leading shield (e.g., 702). In some instances, the side gap insulator comprises an oxide material. In some instances, the side gap insulator is disposed along each sidewall of the metallic side gap (e.g., 710) formed in the cavity.

The PMR write head can also include a metallic side gap (e.g., 710) with at least a portion disposed in the cavity and interior of the side gap insulator layer. The PMR write head can also include a main pole (e.g., 708) with at least a portion disposed in the cavity and interior of the metallic side gap.

In some instances, the PMR write head can also include an additional insulator layer (e.g., 114) disposed between the side gap insulator and the side shield.

In some instances, the additional insulator layer comprises aluminum oxide (AlOx). In some instances, the additional insulator layer comprises a thickness of between 10-500 angstroms (Å).

In another example embodiment, a method for manufacturing a perpendicular magnetic recording (PMR) write head is provided. The method can include forming a leading shield (e.g., 702) The method can also include disposing a side shield (e.g., 704) on a first surface (e.g., top surface) of the leading shield. The side shield can include at least one sidewall portion forming a cavity (e.g., 612) therein.

The method can also include performing an ion milling process at the cavity to form a side gap insulator (e.g., 706) on the at least one sidewall portion. The method can also include disposing at least a portion of a metallic side gap (e.g., 710) in the cavity adjacent to the side gap insulator. The method can also include disposing at least a portion of a main pole (e.g., 708) in the cavity adjacent to the metallic side gap.

In some instances, the side gap insulator comprises an oxide material. In some instances, the ion milling process is performed at an angle of between 0-70 degrees, and an amount milled during the ion milling process is between 50-1000 angstroms (Å).

In some instances, the method can also include providing a current to any part of the PMR write head, wherein the current flows between the main pole and the leading shield. In some instances, the method can also include, after disposing the side shield and prior to performing the ion milling process, disposing an additional insulator layer on the at least one sidewall of the side shield.

In some instances, the additional insulator layer comprises aluminum oxide (AlOx) or other oxides, and wherein the additional insulator layer comprises a thickness of between 10-500 angstroms (Å).

In another example embodiment, a device is provided. The device can include a leading shield and a side shield connected to the leading shield. Sidewall portions of the side shield can form a cavity. The device can also include a side gap insulator disposed within the cavity along the sidewall portions of the side shield.

In some instances, the device can include a metallic side gap with at least a portion disposed in the cavity and interior of the side gap insulator layer and a main pole with at least a portion disposed in the cavity and interior of the metallic side gap.

In some instances, the side gap insulator is configured to cause a current to flow between the main pole and the leading shield. In some instances, the side gap insulator comprises an oxide material.

In some instances, the device can include an additional insulator layer disposed between the side gap insulator and the side shield. In some instances, the additional insulator layer comprises aluminum oxide (AlOx). In some instances, the additional insulator layer comprises a thickness of between 10-500 angstroms (Å).

It will be understood that terms such as “top,” “bottom,” “above,” “below,” and x-direction, y-direction, and z-direction as used herein as terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

It will be appreciated that the term “present invention” as used herein should not be construed to mean that only a single invention having a single essential element or group of elements is presented. Similarly, it will also be appreciated that the term “present invention” encompasses a number of separate innovations, which can each be considered separate inventions. Although the present invention has been described in detail with regards to the preferred embodiments and drawings thereof, it should be apparent to those skilled in the art that various adaptations and modifications of embodiments of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

1. A perpendicular magnetic recording (PMR) write head comprising:
a leading shield;
a side shield connected to the leading shield, wherein portions of the side shield form a cavity;
a side gap insulator disposed within the cavity;
a metallic side gap with at least a portion disposed in the cavity and interior of the side gap insulator layer; and
a main pole with at least a portion disposed in the cavity and interior of the metallic side gap.

2. The PMR write head of claim 1, wherein the side gap insulator is configured to cause a current to flow between the main pole and the leading shield.

3. The PMR write head of claim 1, wherein the side gap insulator comprises an oxide material.

4. The PMR write head of claim 1, wherein the side gap insulator is disposed along each sidewall of the metallic side gap formed in the cavity.

5. The PMR write head of claim 1, further comprising:
an additional insulator layer disposed between the side gap insulator and the side shield.

6. The PMR write head of claim 5, wherein the additional insulator layer comprises aluminum oxide (AlOx) or other oxides.

7. The PMR write head of claim 5, wherein the additional insulator layer comprises a thickness of between 10-500 angstroms (Å).

8. A method for manufacturing a perpendicular magnetic recording (PMR) write head, the method comprising:
forming a leading shield;
disposing a side shield on a first surface of the leading shield, the side shield comprising at least one sidewall portion forming a cavity therein;
performing an ion milling process at the cavity to form a side gap insulator on the at least one sidewall portion;
disposing at least a portion of a metallic side gap in the cavity adjacent to the side gap insulator; and
disposing at least a portion of a main pole in the cavity adjacent to the metallic side gap.

9. The method of claim 8, wherein the side gap insulator comprises an oxide material.

10. The method of claim 8, wherein the ion milling process is performed at an angle of between 0-70 degrees, and an amount milled during the ion milling process is between 50-1000 angstroms (Å).

11. The method of claim 8, further comprising:
providing a current to any part of the PMR write head, wherein the current flows between the main pole and the leading shield.

12. The method of claim 8, further comprising:
after disposing the side shield and prior to performing the ion milling process, disposing an additional insulator layer on the at least one sidewall of the side shield.

13. The method of claim 12, wherein the additional insulator layer comprises aluminum oxide (AlOx) or other oxides, and wherein the additional insulator layer comprises a thickness of between 10-500 angstroms (Å).

14. A device comprising:
a leading shield;
a side shield connected to the leading shield, wherein sidewall portions of the side shield form a cavity; and
a side gap insulator disposed within the cavity along the sidewall portions of the side shield.

15. The device of claim 14, further comprising:
a metallic side gap with at least a portion disposed in the cavity and interior of the side gap insulator layer; and
a main pole with at least a portion disposed in the cavity and interior of the metallic side gap.

16. The device of claim 15, wherein the side gap insulator is configured to cause a current to flow between the main pole and the leading shield.

17. The device of claim 14, wherein the side gap insulator comprises an oxide material.

18. The device of claim 14, further comprising:
an additional insulator layer disposed between the side gap insulator and the side shield.

19. The device of claim 18, wherein the additional insulator layer comprises aluminum oxide (AlOx) or other oxides.

20. The device of claim 18, wherein the additional insulator layer comprises a thickness of between 10-500 angstroms (Å).
